(19) United States
(12) Patent Application Publication
(10) Pub. No.: US 2016/0307411 A1
(43) Pub. Date: Oct. 20, 2016

(54) EXPOSED POKER GAME

(71) Applicant: Russell Boyd, Las Vegas, NV (US)

(72) Inventor: Russell Boyd, Las Vegas, NV (US)

(21) Appl. No.: 15/088,089

(22) Filed: Mar. 31, 2016

Related U.S. Application Data
(60) Provisional application No. 62/149,964, filed on Apr. 20, 2015.

(51) Int. Cl. G07F 17/32; A63F 1/00

(52) U.S. Cl. CPC G07F 17/3293; A63F 1/00; G07F 17/3225; A63F 2001/005

(57) ABSTRACT

An exposed poker game enhances traditional poker games and variants thereof to increase player skill and learning curves. Exposed poker reveals or exposes a player's inoperative cards before they are discarded to permit other players to view such cards. Exposed poker may be implemented at a gaming table or via one or more electronic devices. During game play, each player is required to allow their inoperative cards to be exposed. Exposure of inoperative cards may occur for various predefined periods of time. Thereafter, inoperative cards are discarded.

### CROSS-REFERENCE TO RELATED APPLICATION

This application claims priority to U.S. Provisional Patent Application No. 62/149,964, filed Apr. 20, 2015.

### BACKGROUND OF THE INVENTION

1. Field of the Invention

The invention relates to card games and in particular to systems and methods for an exposed poker game.

2. Related Art

Poker games are popular forms of entertainment and wagering games. A number of poker variants exist, such as flop games, stud games and draw games. Generally speaking, flop games utilize shared or community cards, while stud games and draw games do not. Stud games are dealt in predefined face-up or face-down rounds, while in draw games players discard and draw individual cards to build their hand.

Traditionally, players wager one or more times based on their evaluation of the quality or rank of their hand in comparison to the hands of other players. At the end of a game, the player with best hand, according to a predefined ranking, wins the wager pool. Since randomized or shuffled cards are dealt to players, chance plays a significant role in every poker game. Players can exert their skill on the game as well, but only to a limited extent.

From the discussion that follows, it will become apparent that the present invention addresses the deficiencies associated with the prior art while providing numerous additional advantages and benefits not contemplated or possible with prior art constructions.

### SUMMARY OF THE INVENTION

Systems and methods for an exposed poker game are disclosed herein. As will be detailed more fully below, exposed poker increases player skill, entertainment and learning curves. In addition, exposed poker lowers costs for recording and broadcasting poker games.

Various systems and methods are disclosed herein. In one exemplary embodiment for instance, a method of playing a poker game at a gaming table or on an electronic device is disclosed, with such method comprising shuffling a deck of playing cards, dealing a plurality of cards from the deck of playing cards to a plurality of players to form a hand for each of the plurality of players, and accepting one or more wagers from the plurality of players.

The method also includes receiving one or more inoperative cards from one or more of the plurality of players, exposing the inoperative cards for a predefined period of time, and discarding the inoperative cards after the predefined period of time. The inoperative cards consist of one or more cards from the hand of each of the of the plurality of players.

A pot comprising at least a portion of the wagers is paid to a winning player of the plurality of players when the poker game ends. It is contemplated that the pot may be paid only after the inoperative cards have been exposed and discarded. One or more additional wagers may be accepted prior to payment of the pot and after the inoperative cards have been exposed and discarded.

In addition, one or more replacement cards from the deck of playing cards may be drawn prior to payment of the pot and after the inoperative cards have been exposed and discarded. The replacement cards replace the inoperative cards removed from the hand of each of the of the plurality of players.

A burn card may be selected from the deck of playing cards prior to dealing the cards to the plurality of players. The burn card may be exposed for the predefined period of time and discarded thereafter. The predefined period of time may be defined by a countdown timer at the gaming table or electronic device.

In another exemplary embodiment a method of playing a poker game at a gaming table or on an electronic device comprises: randomizing the order of a plurality of cards in a deck of playing cards, and playing a set of rounds of the poker game.

Each set may be played by distributing one or more cards from the deck of playing cards to a plurality of players to form a hand for each of the plurality of players, accepting one or more wagers from the plurality of players, receiving one or more inoperative cards from the hand of one or more of the plurality of players, and exposing the inoperative cards. The inoperative cards are discarded after they have been exposed. After the set of rounds, a pot comprising at least a portion of the wagers is paid to a winning player of the plurality of players.

It is noted that the set of rounds may consist of at least two rounds. In addition, the inoperative cards may be exposed for a predefined period of time before they are discarded. The predefined period of time may be defined by a countdown timer at the gaming table or electronic device.

Similar to the above embodiment, one or more replacement cards may be drawn from the deck of playing cards during play of the set of rounds. The replacement cards replace the inoperative cards from the hand of each of the of the plurality of players. One or more burn cards may be selected from the deck of playing cards prior to playing the set of rounds. The burn cards may be exposed for a predefined period of time.

In yet another exemplary embodiment, an electronic poker gaming machine is disclosed, with such gaming machine comprising one or more storage devices storing a deck of cards comprising one or more cards, one or more random number generators that randomize the order of the cards in the deck of cards, one or more display devices, and one or more processors.

The processors may provide a set of poker game rounds by assigning a plurality of cards from the deck of playing cards to a plurality of players to form a hand for each of the plurality of players, accepting one or more wagers from the plurality of players, and receiving one or more inoperative cards from the hand of one or more of the plurality of players.

During a set of poker game rounds, the processors also expose the inoperative cards on the display devices, and discarding the inoperative cards after the inoperative cards have been exposed. After the set of poker game rounds, the processors determine a winning player from the plurality of players based on a ranking of their respective hands, and assign a pot comprising at least a portion of the wagers to the winning player.

One or more timers that define a period of time during which the inoperative cards are exposed may be provided as well. The inoperative cards may be discarded after the period of time has elapsed. It is noted that the processors may also select and remove one or more burn cards from the deck of playing cards before the set of poker game rounds is played. The burn cards may be exposed on the display devices before the set of poker game rounds is played.

The processors may also draw one or more replacement cards from the deck of playing cards during the set of poker game rounds. The replacement cards replace the inoperative cards from the hand of each of the of the plurality of players. It is contemplated that the set of poker game rounds may consist of at least two rounds.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a flow diagram illustrating exemplary operation of exposed poker;

FIG. 2 illustrates an exemplary embodiment of an exposed poker game;

FIG. 3 illustrates an exemplary embodiment of an exposed poker game; and

FIG. 4 is a block diagram illustrating an exemplary exposed poker gaming machine.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As will be described further below, exposed poker provides a number of improvements to traditional poker and variants thereof. Namely, exposed poker increases player skill level, increases poker's learning curve, decreases broadcast production costs, and increases engagement and interactivity between its players. Players also generally experience more amusement or fun with exposed poker.

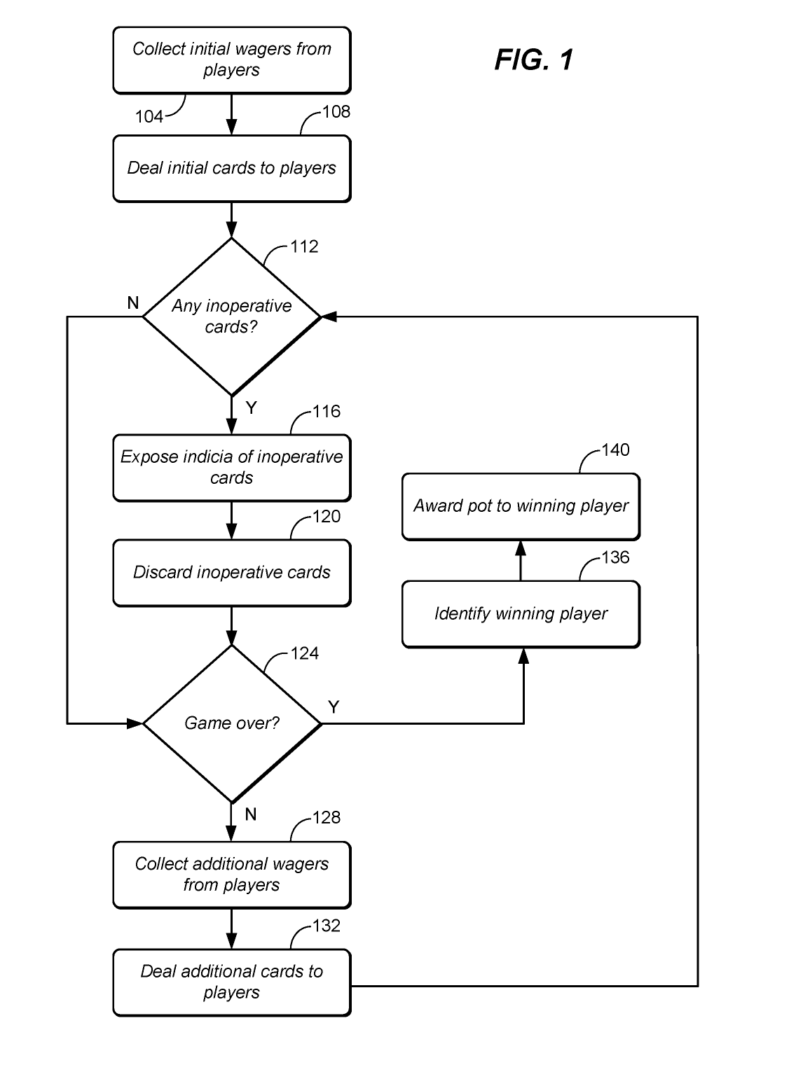

FIG. 1 is a flow diagram illustrating operation of an exemplary exposed poker game. As will now be described, it will become apparent that exposed poker may be embodied or integrated into various poker variants, including draw, community and stud poker variants. At a step 104, an exposed poker game may begin with receipt of one or more initial wagers from one or more players, such as a blind or ante wager. It is noted that an initial wager and receipt thereof is optional.

At a step 108, one or more initial cards may be dealt to the players. It is contemplated that the number of cards dealt may vary. For example, in one variant a complete five card hand may be dealt to each player, while in a community poker variant a partial hand may be dealt to each player. Once cards are dealt, each player may “play” the cards, such as by retaining them in their hand or rendering them inoperative, as will be described further below.

It is noted that the ability to “play” cards is typically defined by the poker variant being played. For example, in a draw poker variant, players may be permitted to retain or discard individual cards after they have been dealt while, in a community poker variant, players may not be permitted to discard cards except for when they fold.

At a decision step 112 it may be determine whether there are any inoperative cards. As used herein, inoperative cards are those that are no longer in play. It is noted that a player may render one or more cards inoperative by discarding the cards for various reasons and at various times. For example, in a draw poker variant, one or more cards may be discarded to draw new cards when building a hand. As another example, the plurality of cards a player holds may be deemed inoperative when the player folds.

It is contemplated that other participants may also render cards inoperative. For example, a dealer may “burn” one or more cards when dealing cards. These cards may then be considered inoperative.

In exposed poker, inoperative cards are exposed. This means that inoperative cards are presented to participants (e.g., players and dealers) such that their indicia are revealed and known to such participants. Thus, if it is determined that one or more inoperative cards exist at decision step 112, the inoperative cards may be exposed at a step 116. Once players, other participants or both have had an opportunity to view the exposed inoperative cards, the inoperative cards may then be discarded at a step 120.

In operation of one exemplary embodiment, inoperative cards may be exposed, at step 116, by presenting them face up to players. One or more predefined areas or locations on a game table, display screen or the like may be provided for presentation of inoperative cards. In addition, exposure may occur for various time periods. For example, inoperative cards may be exposed for a predefined time period. It is contemplated that a countdown timer or other display may be provided to inform players of the time remaining to view exposed cards. As another example, inoperative cards may be exposed until each player provides acknowledgement that they have viewed the exposed inoperative cards.

Thereafter, as stated above, the inoperative cards may be discarded at step 120. In operation, discarding may occur by removing the indicia of the inoperative cards from view. This may occur in various ways. For example, the inoperative cards may be moved into a discard pile, into a shuffling machine, or at the bottom (or other location if desired) of a deck. Alternatively, the inoperative cards may simply disappear from presentation.

At a decision step 124 it may be determined whether the game is over. If so, one or more players may be identified as winners based on their hands at a step 136. Typically, players who have folded their hands will not be eligible for identification as a winning player. In one or more embodiments, such identification includes comparison of these hands to a predefined ranking of hands from best to worst. The player with the best hand may then be identified as the winning player. In the case of a tie, a plurality of players may be winners. At a step 140, the pot containing player wagers may be awarded to the one or more winning players.

If the game is not over at decision step 124, additional wagers may be collected from the players that are still in the game (i.e., the players that have not folded). It is noted that collection of additional wagers may be optional. For example, a player may check and thereby continue playing without placing an additional wager. However, a player may be required to place an additional wager if the player has been raised.

After any additional wagers have been collected at step 128, one or more additional cards may be dealt at a step 132. For example, in a community poker variant one or more of the community cards (e.g., turn, river, flop cards) may be dealt. In a draw poker variant, one or more cards may be “dealt” to players (i.e., drawn from the deck) in response to their discarded cards. In a stud poker variant, one or more cards may simply be dealt to players individually. Again, the players may “play” their dealt cards according to predefined rules of the poker variant being played. Thereafter, the process may continue to decision step 112 where it is determined whether any inoperative (and not yet discarded) cards exist. If so, these inoperative cards may be exposed at step 116 and discarded at step 120, such as described above.

As can be seen, from FIG. 1 and the above disclosure, a number of wagering rounds may occur before a game ends. To illustrate, additional wagers 128 and additional cards 132 may continue to be collected and dealt, respectively, for a number of rounds until it is determined that the game has ended at decision step 124.

It is contemplated that determination of whether a particular game is over at decision step 124 may occur in various ways. Typically, such determination will be based on rules of the poker variant being played. For example, in a community poker variant, a game may be deemed over at decision step 124 after flop cards are dealt at step 132. In a stud poker variant, a game may be deemed over at decision step 124 after the final street of cards are dealt at step 132. In other variants, a game may be deemed over after a predefined number of wagering rounds.

As alluded to above, the required exposure of inoperative cards, such as described with regard to decision step 112 and step 116, is advantageous in various ways. Player skill level is increased by allowing players to correlate game play behavior with outcomes. In other words, players can better discern game play strategies or tendencies of other players because they can view inoperative cards of the other players.

In addition, because inoperative cards are exposed, it is advantageous for each player in a particular poker game to track (or at least attempt to track) which cards are inoperative. This allows players to better define what hands are still possible during game play and the odds of improving to particular hands.

Exposed poker also increases the learning curve for new players because new players can view the indicia of inoperative cards to learn both the rules of a poker game and various strategies for playing the game as well as strategies and/or tendencies of particular players in the game. Moreover, banter, interaction and other communication between players is enhanced because players can converse (or tease/antagonize) about one another's skill or luck or lack thereof during a game once inoperative cards are exposed.

Exposed poker also provides practical benefits to broadcasting of poker games. Since inoperative cards are exposed, the need for specialty camera or recording equipment is reduced or eliminated. This is because a standard overhead camera can be used to capture the inoperative cards. Traditional poker games often require lipstick cameras, RFID or other card tracking tables/equipment, or both to determine the indicia of cards in the game (inoperative or not).

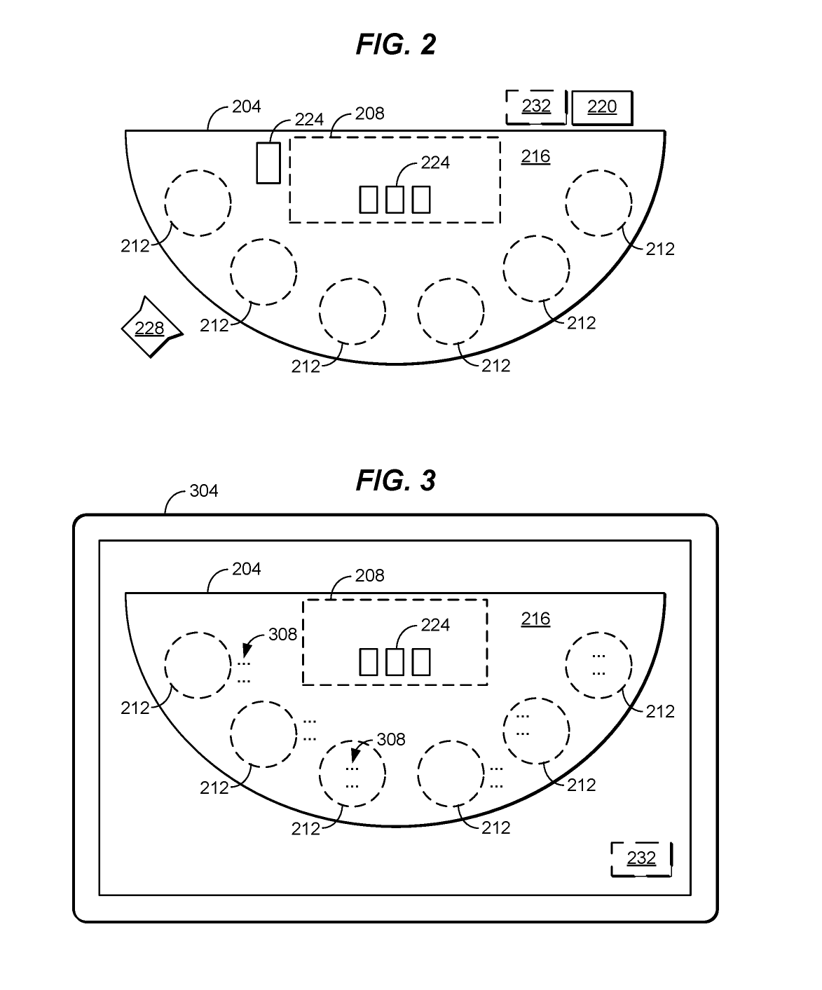

FIG. 2 illustrates an exemplary embodiment of exposed poker. As can be seen, exposed poker may include a gaming table 204 and playing cards 224. A gaming table 204 will typically have a playing surface 216 that supports various game implements, such as playing cards 224, chips, currency or other wagers, or various combinations thereof. A gaming table may also provide one or more player areas 212 on its playing surface 216 where individual players may locate their cards 224, wagers or both. A dealer area 208 may also be provided on a playing surface 216 to receive cards 224, wagers or both. In some embodiments, exposed inoperative cards are presented in a dealer area 208 and removed therefrom when discarded.

A timer 232, clock or the like may optionally be provided to control how long exposed inoperative cards are presented before they are discarded. It is contemplated that a timer 232 may display the amount of time remaining before exposed inoperative cards are discarded. Alternatively, a timer 232 may simply indicate when exposed inoperative cards should be discarded, such as by emitting a light, sound or other signal notifying a dealer to discard the exposed inoperative cards.

Exposed poker may also include a randomizer, such as an automatic card shuffler 220. One or more card shoes 224 may be used to dispense randomized/shuffled cards 224, such as when cards are being dealt to players. One or more cameras 228 may be provided as well to capture at least the exposed inoperative cards, such as for recording or broadcast purposes. It is contemplated that, after exposure, inoperative cards may be discarded by returning them to the bottom (or other location) of a stack of cards 224 in a card shoe 224.

FIG. 3 illustrates another exemplary embodiment of exposed poker. As can be seen, exposed poker may be implemented electronically and presented via a display device 304, such as a monitor, screen, projector or the like. It is contemplated that exposed poker may be presented in various ways. As shown in FIG. 3 for example, exposed poker is presented as a table game played at a gaming table 204. Similar to above, the gaming table 204 here may include one or more player areas 212 and dealer areas 208 on a playing surface 216 of the gaming table.

Cards 224 may be presented on the playing surface 216 at one or more player areas 212, a dealer area 208 or both. In addition to playing card indicia of one or more cards 224, other indicia 308 may be presented as well. For example, wager information (e.g., amounts wagered), player identifiers (e.g., player names, usernames, or images), and game indicators (e.g., dealer and other buttons) may be presented. Such indicia 308 may be presented in or adjacent to a player area 212 to associate the indicia with a particular player.

It is contemplated that exposed poker may be played, in an electronic embodiment, by players at various locations. To illustrate, one or more players may connect to and play exposed poker via a gaming machine at a gaming establishment, a gaming terminal at a remote location or via other client devices such as game consoles, desktop or laptop computers, tablet devices, or smartphones or other mobile devices.

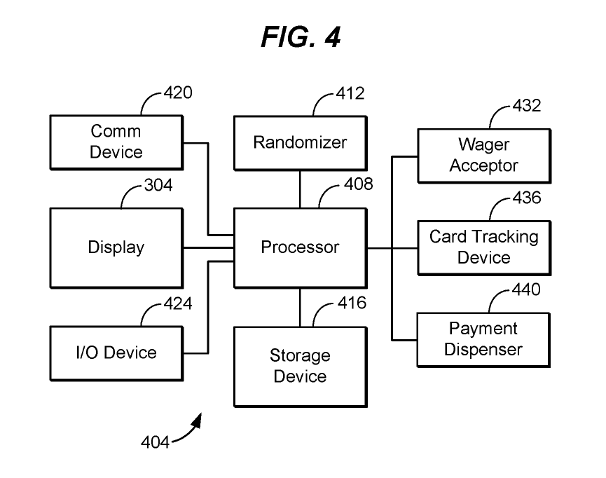

FIG. 4 illustrates an exemplary exposed poker gaming machine 404. As can be seen, a gaming machine 404 may comprise one or more processors 408, storage devices 416, and display devices 304. In operation a processor 408 may execute one or more instructions to provide exposed poker electronically. Instructions may be hard wired into a processor 408 or may be stored or fixed on a tangible medium that is in or readable by a storage device 416.

A storage device 416 may also store various game information, such as the wager information, player information, and game indicators described above. A storage device 416 may be configured for temporary or permanent data storage. In addition, a storage device 416 may be integrated into a processor 408. Some exemplary data storage technologies for one or more storage devices include, magnetic, flash, PROM, or optical storage.

One or more randomizers 412 will typically be included as well. A randomizer may be a random number generator that is separate from (such as shown) or integrated into a processor 408. A randomizer may be used to randomize or shuffle cards for game play purposes.

One or more I/O devices 424 may be included as well, such as to receive input from players, control accessories, or both. For example, an I/O device 424 may receive wager information via one or more buttons. As another example, an I/O device 424 may control various indicators, such as lights or speakers, of a gaming machine 404.

In some embodiments, a gaming machine 404 may be a server that hosts multiple players. Therefore, in some embodiments input and output may be communicated via a communication device 420. For example, player input may be received from a client device via a communication device 420. A communication device 420 may utilize various communication protocols and be arranged to communicate via one or more wired or wireless communication links. For instance, remote players may communicate with a gaming machine 404 via a wide area network, such as the Internet, or via a local area network or direct connection through their client device. In such case, a gaming machine 404 will typically forgo presentation of exposed poker on a display 304 and instead transmit such presentation to a player's client device via a communication device 420.

One or more optional wager acceptors 432, card tracking devices 436, payment dispensers 440 or various combinations thereof may be included as part of a gaming machine 404. In operation, a wager acceptor 432 accepts wagers in various forms. For example, a wager acceptor 432 may accept and read bills, coins, tokens, tickets. In addition, a wager acceptor 432 may accept player input. For example, a wager acceptor 432 may include a button that allows a player to input a wager. A payment dispenser 440 may a device which dispenses physical payment, such as tokens, tickets or bills, or may dispense payment by electronically associating credits, currency or the like with a particular player's account. Typically, a payment dispenser 440 will be used to award a pot to a winning player or to return credits to a player if the player wishes to stop playing.

A card tracking device 436 will typically be provided only if the gaming machine 404 is at a gaming table. A card tracking device 436 may utilize RFID or optical recognition to read and track the location or disposition (e.g., whether cards are operative or inoperative) of cards. This may be used for broadcast purposes, such as to televise or otherwise broadcast an exposed poker game. A card tracking device 436 may also be used to record the movement and disposition of cards in exposed poker games. It is contemplated that a wager acceptor 432 and payment dispenser 440 will typically be provided only when the gaming machine 404 is not implemented as a server.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method of playing a poker game at a gaming table or on an electronic device comprising:
shuffling a deck of playing cards;
dealing a plurality of cards from the deck of playing cards to a plurality of players to form a hand for each of the plurality of players;
accepting one or more wagers from the plurality of players;
receiving one or more inoperative cards from one or more of the plurality of players, the one or more inoperative cards consisting of one or more cards from the hand of each of the one or more of the plurality of players;
exposing the one or more inoperative cards for a predefined period of time;
discarding the one or more inoperative cards after the predefined period of time; and
paying a pot comprising at least a portion of the one or more wagers to a winning player of the plurality of players when the poker game ends.

2. The method of claim 1 further comprising exposing a burn card selected from the deck of playing cards prior to dealing the one or more cards to the plurality of players.

3. The method of claim 2, wherein the burn card is exposed for the predefined period of time and discarded thereafter.

4. The method of claim 1, wherein the pot is paid only after the one or more inoperative cards have been exposed and discarded.

5. The method of claim 1 further comprising accepting one or more additional wagers prior to payment of the pot and after the one or more inoperative cards have been exposed and discarded.

6. The method of claim 1 further comprising drawing one or more replacement cards from the deck of playing cards prior to payment of the pot and after the one or more inoperative cards have been exposed and discarded, wherein the one or more replacement cards replace the one or more inoperative cards removed from the hand of each of the one or more of the plurality of players.

7. The method of claim 1, wherein the predefined period of time is defined by a countdown timer at the gaming table or electronic device.

8. A method of playing a poker game at a gaming table or on an electronic device comprising:
randomizing the order of a plurality of cards in a deck of playing cards;
playing a set of rounds of the poker game by:
distributing one or more cards from the deck of playing cards to a plurality of players to form a hand for each of the plurality of players;
accepting one or more wagers from the plurality of players;
receiving one or more inoperative cards from the hand of one or more of the plurality of players;
exposing the one or more inoperative cards; and
discarding the one or more inoperative cards after they have been exposed; and
after the set of rounds, paying a pot comprising at least a portion of the one or more wagers to a winning player of the plurality of players.

9. The method of claim 8, wherein the set of rounds consists of at least two rounds.

10. The method of claim 8, wherein the one or more inoperative cards are exposed for a predefined period of time before they are discarded.

11. The method of claim 10, wherein the predefined period of time is defined by a countdown timer at the gaming table or electronic device.

12. The method of claim 8 further comprising drawing one or more replacement cards from the deck of playing cards during play of the set of rounds, wherein the one or more replacement cards replace the one or more inoperative cards from the hand of each of the one or more of the plurality of players.

13. The method of claim 8 further comprising exposing one or more burn cards selected from the deck of playing cards prior to playing the set of rounds.

14. The method of claim 13, wherein the one or more burn cards are exposed for a predefined period of time.

15. An electronic poker gaming machine comprising:
one or more storage devices storing a deck of cards comprising one or more cards;
one or more random number generators that randomize the order of the one or more cards in the deck of cards;
one or more display devices; and
one or more processors that provide a set of poker game rounds by:
assigning a plurality of cards from the deck of playing cards to a plurality of players to form a hand for each of the plurality of players;
accepting one or more wagers from the plurality of players;
receiving one or more inoperative cards from the hand of one or more of the plurality of players;
exposing the one or more inoperative cards on the one or more display devices; and
discarding the one or more inoperative cards after the one or more inoperative cards have been exposed;
wherein, after the set of poker game rounds, the one or more processors determine a winning player from the plurality of players based on a ranking of their respective hands, and assign a pot comprising at least a portion of the one or more wagers to the winning player.

16. The gaming machine of claim 15 further comprising one or more timers that define a period of time during which the one or more inoperative cards are exposed, wherein the one or more inoperative cards are discarded after the period of time has elapsed.

17. The gaming machine of claim 15, wherein the one or more processors also select and remove one or more burn cards from the deck of playing cards before the set of poker game rounds is played.

18. The gaming machine of claim 17, wherein the one or more burn cards are exposed on the one or more display devices before the set of poker game rounds is played.

19. The gaming machine of claim 15, wherein the one or more processors draw one or more replacement cards from the deck of playing cards during the set of poker game rounds, wherein the one or more replacement cards replace the one or more inoperative cards from the hand of each of the one or more of the plurality of players.

20. The gaming machine of claim 15, wherein the set of rounds consists of at least two rounds.
